(19) United States
(12) Patent Application Publication
(10) Pub. No.: US 2005/0193079 A1
(43) Pub. Date: Sep. 1, 2005

(54) Providing notification of an undelivered portion of an electronic mail message based upon a scheduled time

(75) Inventors: Michael W. Brown, Georgetown, TX (US); Michael A. Paolini, Austin, TX (US); Newton J. Smith, Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/787,982

(22) Filed: Feb. 26, 2004

(51) Int. Cl. G06F 15/16

(52) U.S. Cl. 709/207; 709/206

(57) ABSTRACT

A method and an apparatus for providing notification of an undelivered portion of an electronic mail message based upon a scheduled time. The method includes determining that less than all of an electronic mail message has been transmitted, the electronic mail message including scheduling information indicative of a calendar event, associating the electronic mail message with the calendar event based upon the scheduling information, and providing a notification that less than all of the electronic mail message has been transmitted based on the calendar event.

### BACKGROUND OF THE INVENTION

1. Field of the Invention

This invention relates generally to electronic mail messaging, and, more particularly, to providing a notification of an undelivered portion of an electronic mail message based upon a scheduled time.

2. Description of the Related Art

Electronic mail has become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

Thus, depending on the circumstances, electronic mail messages may be transmitted and/or received by a wide variety of devices at any given time. In addition to the aforementioned end-user devices, such as desktop computers, laptop computers, cell phones, personal digital assistants, and the like, electronic mail messages typically also pass through a variety of network servers, network switches, hubs, routers, transmission lines, wireless transmission media, modems, interface cards, and the like. The transfer rates of these devices and/or media can vary by many orders of magnitude. For example, a laptop computer's modem may be limited to a transfer rate of 56K bits per second, a cable modem may easily provide data at a transfer rate of 1-2 megabits per second, and a T-3 connection may provide data at a transfer rate as high as 40 megabits per second.

The complexity and size of electronic mail messages has increased roughly in proportion with the available transfer rate. Early electronic mail message systems relied upon comparatively slow modems and thus these electronic mail messages were typically limited to short ASCII text documents. Modern electronic mail messaging systems, on the other hand, may utilize high-speed connections to transmit documents containing complex formatting, audio, graphics, video, and the like. For example, a user may send and/or receive an electronic mail messages with a PowerPoint attachment including formatted text, images, and animations. For another example, a user with the appropriate licenses may send and/or receive a feature length movie as an electronic mail message. The size of these files may easily exceed several megabytes, and users may expect to transmit even larger files in the future.

Despite the advantages of using high-speed connections to transmit large information-rich electronic mail messages, the same messages can become problematic when they must be transmitted by a lower speed connection. For example, a user reading electronic mail messages on a laptop computer connected to the Internet via a 14.4K dial-up modem may have to wait an inordinate amount of time for a large electronic mail message to be downloaded through the modem. As another example, a user writing electronic messages on the laptop computer connected to the Internet via a 14.4 KB dial-up modem may want to attach a large document to an electronic mail message, but may have to wait an unreasonable amount of time for the electronic mail message to be uploaded through the modem. In addition, bottlenecks, heavy traffic, device malfunctions, severed transmission lines, geomagnetic storm, and the like can dramatically, and often unpredictably, decrease the transfer rate of even the highest speed networks.

Electronic mail messages are often used to schedule meetings and to distribute materials that may be useful to the participants in the meeting. For example, electronic mail may be an efficient way to transmit documents to geographically dispersed participants in a teleconference, a video conference, and the like. However, it may be difficult for some participants to receive these documents if, for example, the files containing the documents are relatively large and the participants are receiving the electronic mail message via a low speed connection. Thus, the participants may not be able to timely receive the documents for the scheduled meeting.

The present invention is directed to addressing, or at least reducing, the effects of, one or more of the problems set forth above.

### SUMMARY OF THE INVENTION

In one aspect of the instant invention, a method of providing a notification of an undelivered portion of an electronic mail message based upon a calendar entry is presented. The method includes determining that less than all of an electronic mail message has been transmitted, the electronic mail message including scheduling information indicative of a calendar event, associating the electronic mail message with the calendar event based upon the scheduling information, and providing a notification that less than all of the electronic mail message has been received based on the calendar event.

In another aspect of the instant invention, a method of providing a notification of an undelivered portion of an electronic mail message based a determined transfer rate value, a determined value associated with a size of the undelivered portion of the electronic mail message, and the calendar event is presented. The method includes determining that less than all of an electronic mail message has been transferred, the electronic mail message including scheduling information indicative of a calendar event, and associating the electronic mail message with the calendar event based upon the scheduling information. The method also includes providing a notification that less than all of the electronic mail message has been received based on the calendar event, determining a value associated with a data transfer rate, and determining a value associated with a size of an undelivered portion of the electronic mail message. The method further includes scheduling a transfer time for the undelivered portion of the electronic mail message based upon the determined transfer rate value, the determined value associated with the size of the electronic mail message, and the calendar event.

In yet another aspect of the present invention, a method for interfacing with a user of a computer system having a graphical user display is provided. The method includes displaying at least one indicator of an event associated with at least one undelivered portion of at least one electronic mail message, monitoring the position and selection status of a pointer controller to detect that one of the at least one indicator has been selected by the user, and providing scheduling information associated with the at least one undelivered portion of the at least one electronic mail message and the event in response to detecting that one of the at least one indicators has been selected by the user.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a system for practicing one or more embodiments of the present invention.

FIG. 2 shows one embodiment of an e-mail that may be stored by an e-mail management module, in accordance with one embodiment of the present invention.

FIG. 3 conceptually illustrates one alternative embodiment of a system that may implement one or more embodiments of the present invention.

FIG. 4 illustrates one embodiment of a method for providing a portion of an electronic mail message, in accordance with one embodiment of the present invention.

FIG. 5A shows one embodiment of a user profile, in accordance with one embodiment of the present invention.

FIG. 5B shows one embodiment of a dialog box, in accordance with one embodiment of the present invention.

FIG. 5C shows one embodiment of a calendar entry, in accordance with one embodiment of the present invention.

FIG. 6 shows one embodiment of a dialog box including scheduling information, in accordance with one embodiment of the present invention.

FIG. 7 illustrates one embodiment of a method for providing a notification of an undelivered portion of an electronic mail message, in accordance with one embodiment of the present invention.

FIG. 8 shows one embodiment of a notification, in accordance with one embodiment of the present invention.

FIG. 9 shows one embodiment of an urgent notification, in accordance with one embodiment of the present invention.

FIG. 10 illustrates one embodiment of a method for providing an electronic mail message, in accordance with one embodiment of the present invention.

FIG. 11 shows a stylized block diagram of a processor-based device, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e. a definition that is different from the ordinary and customary meaning as understood by those skilled in the art, is intended to be implied by consistent usage of the term or phrase herein. To the extent that a term or phrase is intended to have a special meaning, i.e. a meaning other than that understood by skilled artisans, such a special definition will be expressly set forth in the specification in a definitional manner that directly and unequivocally provides the special definition for the term or phrase.

As will be described in detail below, the present invention provides for intelligent use of the bandwidth available for transmitting electronic mail messages. For example, in one embodiment of the present invention, an e-mail server may autonomously decide whether an electronic mail message should be uploaded and/or downloaded based upon operating conditions such as a connection speed of a local system to a remote server and a scheduled time and/or event. In another embodiment, a user may decide, manually or using an automated process based upon selected user preferences, what portions of an e-mail associated with a scheduled time and/or event are sent and/or received. The user, or the e-mail server, may then be provided with a notification indicating that an undelivered portion of the electronic mail message remains, and requesting that the user, or the e-mail server, complete transmitting the electronic mail message before a scheduled time and/or event.

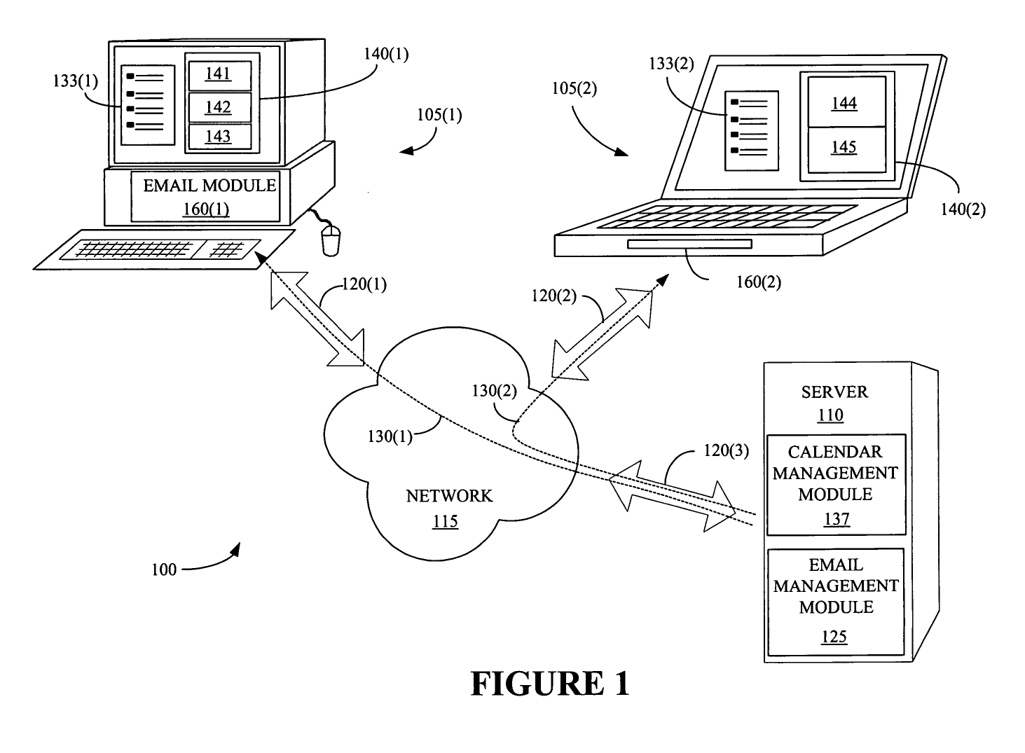

FIG. 1 illustrates a system 100 for practicing one or more embodiments of the present invention. In particular, FIG. 1 conceptually illustrates an embodiment that includes a plurality of processor-based devices 105(1-2) coupled to a server 110 by a network 1115. In the illustrated embodiment, the processor-based device 105(1) is a desktop computer and the processor-based device 105(2) is a laptop computer, although in other embodiments, these processor-based devices 105(1-2) may be any desirable type of computer, personal digital assistant, cellular telephone, and the like.

The server 110, in one embodiment, may be one form of a processor-based device that can be accessed over the network 115. In accordance with one embodiment of the present invention, and as discussed below, the server 110, if desired, provides a less than the entire electronic mail message to a remote user. In one embodiment, the server 110 may be capable of performing tasks such as receiving, queuing, storing, and/or distributing e-mails to one or more users. Although not so limited, in one embodiment, one or more of the described embodiments of the present invention can be implemented within a conventional e-mail server, such as a Microsoft® Exchange Server. In the interest of clarity, the potential functionality of the server 110 not related to the present invention will not be described in further detail, as these tools and/or features are well known to persons of ordinary skill in the art.

In the embodiment illustrated in FIG. 1, the processor-based devices 105(1-2) and the server 110 are communicatively coupled to the network 115 over one or more communications links 120(1-3). In various alternative embodiments, the links 120(1-3) may be one or more of infrared links, wireless local area network (LAN) links, wired LAN connections such as Ethernet connections, cellular network links, circuit board traces, wires, cables, radiofrequency links, satellite links, and the like. Moreover, any desirable protocol may be used for communications between the processor-based devices 105(1-2) and the server 110 via the network 115. For example, a transmission control protocol/Internet protocol (TCP/IP), a user datagram protocol/Internet protocol (UDP/IP), a file transfer protocol or trivial file transfer protocol (FTP/TFTP), and the like may be used.

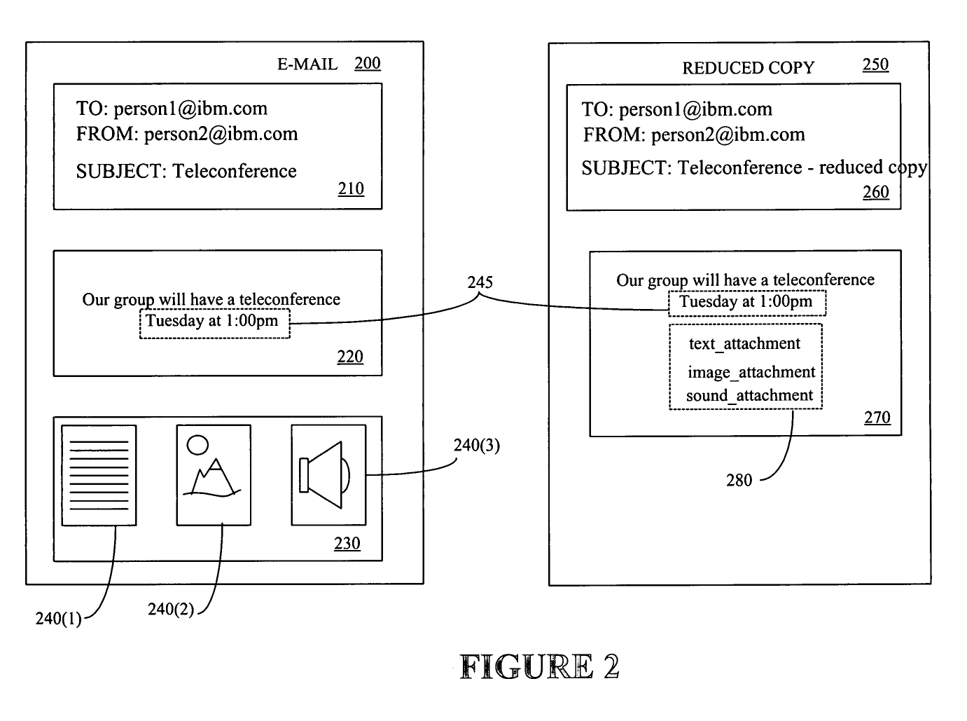

In the embodiment illustrated in FIG. 1, the server 110 includes an e-mail management module 125, which may process (e.g. receive, queue, store, and/or deliver) one or more one or more electronic mail messages, hereinafter referred to as e-mails, in accordance with common usage in the art. One form of an e-mail 200 that may be processed by the e-mail management module 125 is shown in FIG. 2. In the embodiment illustrated in FIG. 2, the e-mail 200 includes a header 210, a body 220, and one or more attachments 230. The header 210 generally includes information indicative of one or more designated recipients of the e-mail (i.e. person1@ibm.com), the sender or distributor (i.e. person2@ibm.com), and the subject of the e-mail 200 (i.e. Teleconference). The body 220 generally includes the message being conveyed. For example, in the e-mail 200, the body includes a text string, “Our group will have a teleconference.”

The e-mail message 200 shown in FIG. 2 also includes attachments 240(1-3) that, in the illustrated embodiment, include a text document 240(1), a graphics file 240(2), and an audio file 240(3). However, persons of ordinary skill in the art will appreciate that any desirable number of files, as well as any desirable type and/or format of file, may be attached to the e-mail 200. Additionally, it should be appreciated that the e-mail 200 illustrated in FIG. 2 is exemplary in nature, and that in other embodiments it may include more, fewer, or different elements. For example, the e-mail 200 may only include a header 210 and a body 220. As another example, the e-mail 200 may also include routing information that may be used to direct the e-mail 200 to a desired destination.

The e-mail 200 may also have an associated time field 245 that includes an indication of a time associated with the e-mail 200. In the illustrated embodiment, the associated field 245 includes a day (Tuesday) and a time (1:00 pm) which may correspond to, for example, a scheduled day and time of a meeting. However, the present invention is not limited to any one particular format employed for the associated field 245. In alternative embodiments, any desirable format for the field 245 may be used. For example, the time “Jan. 1, 2000 at 12:00 am” may also be represented by “Jan. 1, 2000 at midnight,” “Jan. 1, 2000—12:00 am,” and the like. Alternatively, the e-mail 200 may include an indication of an event associated with the e-mail 200, such as the teleconference indicated in the exemplary e-mail 200 shown in FIG. 2.

Referring back to FIG. 1, in one embodiment, the e-mail 200 may be associated with one or more calendars 133(1-2), 137. For example, the header 141, body 142, and attachments 143 may be associated with an entry in one or more of the calendars 133(1-2), 137. In various alternative embodiments, the calendars 133(1-2), 137 may be the calendars 133(1-2) maintained on the processor based devices 105(1-2), respectively, and/or the calendar management module 137 maintained on the server 110. For example, the calendars 133(1-2) may be provided by copies of Microsoft Outlook® that are running on the processor based devices 105(1-2). However, in alternative embodiments, any desirable scheduling and/or calendar tool may be used.

The e-mail management module 125 on the server 110 may provide the e-mail 200, or a selected portion, to one or more designated recipients, which, for illustrative purposes, are assumed to be the users of the processor-based systems 105(1-2). Thus, in this illustrative example, the e-mail management module 125 provides at least the selected portion of the e-mail 200 to the processor-based devices 105(1-2). However, persons skilled in the art will appreciate that, in alternative embodiments, any number of users of any desirable processor-based systems may be designated as the recipients and may receive portions of the e-mail 200 provided by the e-mail management module 125. The portion of the e-mail 200 transmitted to the user of each processor-based device 105(1) and 105(2) is hereinafter designated in FIG. 1 by reference numbers 140(1) and 140(2), respectively.

The e-mail management module 125 may provide the e-mail 200 via a variety of communication paths 130(1-2). In the illustrated embodiment, the e-mail management module 125 may transmit a selected portion of the e-mail 200 (designated by reference number 140(1)) to the processor-based device 105(1) along the communication path 130(1), which may include the link 120(3), the network 115, and the link 120(1). The e-mail management module 125 may also transmit a selected portion of the e-mail 200 (designated by reference number 140(2)) to the processor-based device 105(2) along the communication path 130(2), which may include the link 120(3), the network 115, and the link 120(2). Those skilled in the art will appreciate that communications paths 130(1-2) may include one or more intermediate gateways (not shown), routers (not shown), and the like.

As explained above, the data transfer rate along the communication paths 130(1-2) may vary by many orders of magnitude. For example, the communication path 130(1) may consist of a dedicated T-3 connection that may provide data at a transfer rate as high as 40 megabits per second. Accordingly, even if the attachments 240(1-3) attached to the e-mail 200 are large, e.g. 100 MB, the total time required to transfer the copy 140(1) may remain comparatively low, e.g. a few seconds in the case of the 100 MB attachments 240(1-3). In contrast, the communication path 130(2) may include a dial-up connection, such as the link 120(2), which may transfer data at a much lower rate. Thus, a user may have to wait several hours for the 100 MB attachments 240(1-3) to be transferred via the communication path 130(2). The long transfer time may inconvenience the user, particularly if the user does not wish to see the attachments 240(1-3), but does want to see one or more e-mails that may be transferred subsequently from the server 110.

In order to reduce the potential inconvenience to the user and increase the efficiency of the system 100, the e-mail management module 125, in one embodiment, may only transfer a portion of the e-mail 200 along one or more of the communication paths 130(1-2). For example, as will be discussed in detail below, the e-mail management module 125 may estimate a data transfer rate for the communication paths 130(1-2) and a size of the e-mail 200. In one embodiment, the estimated data transfer rate and the estimated size of the e-mail 200 may be used to estimate the time required to transfer the e-mail 200 along the communication paths 130(1-2).

The e-mail management module 125 may also determine a threshold time, such as a user's maximum preferred time to transfer the e-mail 200, and compare the determined threshold to the estimated e-mail transfer time. For example, the user may select a maximum preferred transfer time of approximately one minute. For another example, the user may select a maximum preferred transfer time of approximately zero minutes to force the e-mail management module to provide a reduced copy 140(2) of all e-mails 200. Alternatively, the threshold time may be a default time.

If the estimated e-mail transfer time is substantially less than the predetermined threshold time, the e-mail management module 125 may transmit substantially all of the e-mail 200. For example, the processor-based device 105(1) may receive the complete copy 140(1) of the e-mail message 200, including a header 141, a body 142, and one or more attachments 143. However, if the estimated e-mail transfer time is substantially more than the predetermined threshold time, and it is not desirable to transmit the entire e-mail 200, the e-mail management module 125 may transmit a portion of the e-mail 200. For example, the processor-based device 105(2) may receive the reduced copy 140(2) of the e-mail message 200, including a header 144 and a body 145.

FIG. 2 shows one embodiment of a reduced copy 250, which includes a header 260 and a body 270. The header 260 includes information indicative of the recipients of the e-mail (i.e. person1@ibm.com), the sender (i.e. person2@ibm.com), and the subject of the e-mail 200 (i.e. Teleconference—reduced copy). The body 270 includes a text string, “Our group will have a teleconference.” In addition, it one embodiment, the body 270 may also include an additional text string 280 that indicates the contents of the attachments 240(1-3). In the illustrated embodiment, the additional text string 280 includes the strings “text_attachment,” “image_attachment,” and “audio_attachment.” Although not shown in the FIG. 2, the additional text string 280 may include other information, such as an estimated size of the attachments 240(1-3), the estimated transfer time for the entire e-mail 200 and/or for the attachments 240(1-3), and the like. In alternative embodiments, the reduced copy 250 may also include downcasted portions of one or more attachments 240(1-3), selected portions of one or more attachments 240(1-3), and the like.

Referring back to FIG. 1, the e-mail management module 125 may queue and/or store the e-mail 200. For example, if the reduced copy 140(2) has been transmitted to the processor-based device 105(2), the e-mail 200 may be queued and/or stored until a higher speed connection is available. As will be described in detail below, the e-mail management module 125 may also provide a notification indicating that a portion of the e-mail 200 has not been delivered to the intended recipient, in accordance with one embodiment of the present invention. For example, the e-mail management module 125 may determine that the current time is approaching the associated time 245, i.e. the time of the scheduled teleconference. Depending on how close the current time is to the associated time 245, the e-mail management module 125 may provide notifications more frequently and/or with higher urgency. In one embodiment, the e-mail management module 125 may provide a late notice if the current time exceeds the associated time 245.

A user may request that the undelivered e-mail 200 be downloaded to the processor-based devices 105(2). In one embodiment, the notification may include giving the user an option to download the e-mail 200 and the user may request that the e-mail 200 be downloaded in response to the notification. In one embodiment, the e-mail management module 125 may download substantially all of the e-mail 200 to the one or more of the processor-based device 105(2). However, in alternative embodiments, the e-mail management module 125 may “trickle download” the e-mail 200, i.e. successively download portions of the e-mail 200 in the background during one or more sessions, to the processor-based device 105(2). In one embodiment, the e-mail management module 125 may notify the user to indicate what choices are available, e.g. downloading substantially all of the e-mail 200 or trickle downloading the e-mail 200, and/or what actions have taken place.

In one embodiment, the processor-based devices 105(1-2) may include e-mail modules 160(1-2), which may carry out a portion of the aforementioned processes or additional processes. For example, the e-mail modules 160(1-2) may allow a user to set up preferences as to how electronic mail messages are to be handled. When the user is ready to process electronic mail messages, the e-mail modules 160(1-2) may send a message to the server 110, such as a POP3 or IMAP server 110, which may cause various flags to be set based upon the user preferences. Electronic mail messages may then be processed in accordance with the user preferences indicated by the flags, as will be discussed in detail below. The modules 125, 160(1-2) illustrated in FIG. 1 are implemented in software, although in other implementations the modules 125, 160(1-2) may also be implemented in hardware or a combination of hardware and software.

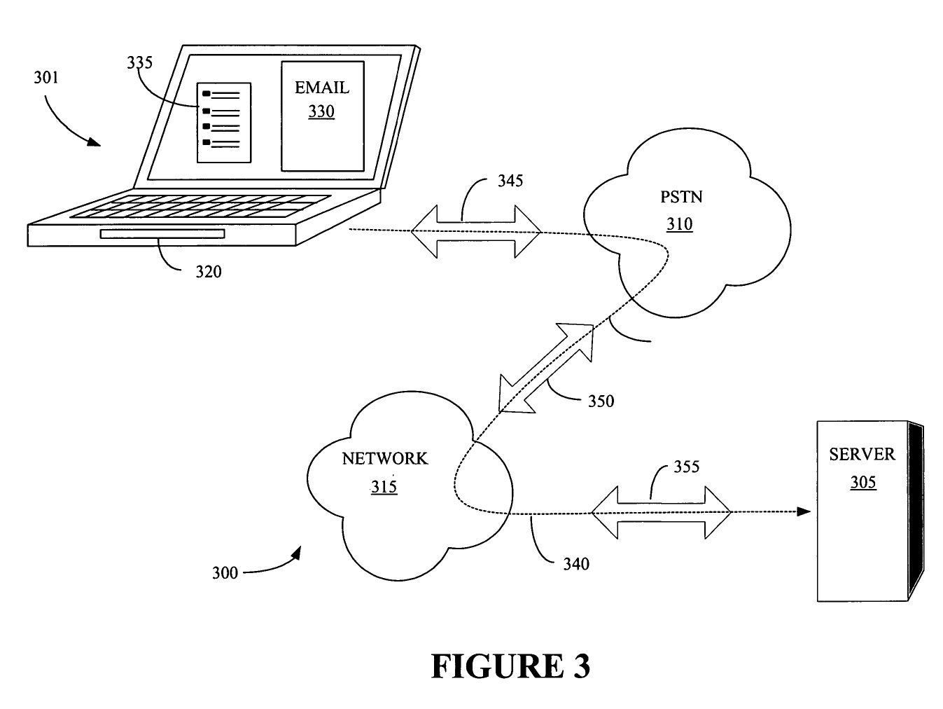

FIG. 3 conceptually illustrates a system 300 that may implement one or more alternative embodiments of the present invention. In FIG. 3, a processor-based device 301 is communicatively coupled to a server 305 by a public switched telephone network (PSTN) 310 and a network 315. Thus, the transmission of e-mails from the processor-based device 301 to the server 305 may be implemented in the alternative embodiment shown in FIG. 3. In various alternative embodiments, the processor-based device 301 may allow one or more users to create and/or send an e-mail 330 or the processor-based device 301 may be an automated mail server that may create and/or send the e-mail 330. The e-mail 330 may also have an associated time, such as the associated time indicated in the associated time field 245 shown in FIG. 2. As discussed in detail above, in one embodiment, the e-mail 330 may be associated with a calendar 335 using the associated time.

In the illustrated embodiment, the processor-based device 301 includes an e-mail management module 320 that may provide a copy of the e-mail 330 to the server 305. For example, in the illustrated embodiment, the e-mail management module 320 may transmit at least a portion of the e-mail 330 to the server 310 along the communication path 340, which may include the link 345, the public switched telephone network 310, the link 350, the network 315, and the link 355. As discussed above, the data transfer rate along the communication path 340 may vary by many orders of magnitude. For example, if the processor-based device 301 is linked to the public switched telephone network (PSTN) 310 via a 14.4 KB modem (not shown), it may not be desirable to transmit a 100 MB attachment (not shown) to the server 305. Thus, the e-mail management module 320 may only transmit a portion of the e-mail 330 along the communication path 340.

In one embodiment, after transmitting the portion of the e-mail 330 along the communication path 340, the e-mail management module 320 may queue and/or store the e-mail 330 until a faster connection is available. For example, a user may later connect the processor-based device 301 to the network 315 via a higher-speed connection, such as an Ethernet, and then the e-mail management module 320 may transmit the e-mail 330 using the higher speed connection. As will be described in detail below, the e-mail management module 320 may also provide a notification indicating that a portion of the e-mail 330 has not been delivered to the intended recipient, i.e. the server 305, in accordance with one embodiment of the present invention. For example, the e-mail management module 320 may determine that the current time is approaching the associated time 245, i.e. the time of the scheduled teleconference. Depending on how close the current time is to the associated time 245, the e-mail management module 320 may provide notifications more frequently and with higher urgency. In one embodiment, the e-mail management module 320 may provide a late notice if the current time exceeds the associated time 245.

In response to the notification, the undelivered e-mail 330 may be uploaded to the server 305. In one embodiment, the notification may include giving a user an option to upload the e-mail 330 and the user may request that the e-mail 330 be uploaded in response to the notification. In one embodiment, the e-mail management module 320 may upload substantially all of the e-mail 330 to the server 305. However, in alternative embodiments, the e-mail management module 320 may “trickle upload” the e-mail 330, i.e. successively upload portions of the e-mail 330 in the background during one or more sessions, to the server 305. In one embodiment, the e-mail management module 320 may notify the user to indicate what choices are available, e.g. uploading substantially all of the e-mail 330 or trickle uploading the e-mail 330, and/or what actions have taken place.

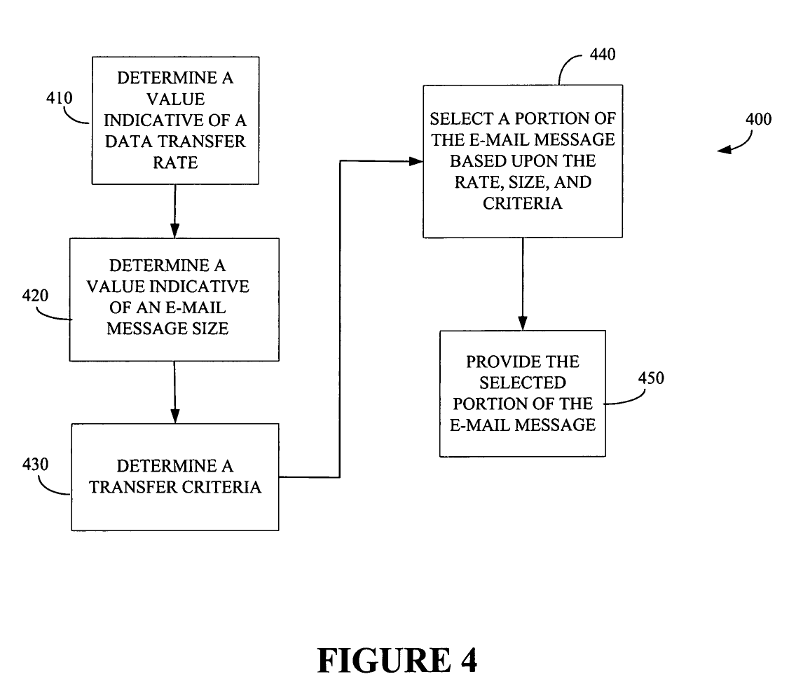

FIG. 4 illustrates one embodiment of the method of 400 for providing a portion of an electronic mail message based upon a data transfer rate, a size of the electronic mail message, and a threshold time. In the illustrated embodiment, a value indicative of, or associated with, a data transfer rate is determined (at 410). For example, an e-mail management module, such as the e-mail management modules 125, 320 and/or the e-mail modules 160(1-2), may determine (at 410) an average data transfer rate using one or more data packets received within a time period. Alternatively, the e-mail management module may determine (at 410) a data transfer rate using a device profile. For example, the e-mail management module may determine (at 410) that a 14.4 KB modem is being used to transmit data and, thus, the e-mail management module may determine (at 410) that the data transfer rate may not exceed approximately 14.4 KB. Persons of ordinary skill in the art should appreciate that the aforementioned techniques for determining (at 410) the data transfer rate are exemplary and not intended to limit the present invention.

A value indicative of, or associated with, a size of an electronic mail message is also determined (at 420). In one embodiment, the e-mail management module may determine (at 420) the size of the electronic mail message by determining (at 420) the number of bits in the electronic mail message. Alternatively, the size of the electronic mail message may be determined (at 420) using information that may be transmitted with the electronic mail message.

A mail transfer criteria is also determined (at 430). In the previously discussed embodiments of the present invention, the mail transfer criteria has been associated with a mail transfer threshold time, such as a user's preferred maximum transfer time or a default threshold time. In these embodiments, the mail transfer criteria is determined (at 430) by determining the threshold time using an indication of the user's preferred maximum transfer time, such as a user profile, or an indication of the default threshold time. However, the potential mail transfer criteria are not limited to the threshold time. In alternative embodiments, the mail transfer criteria may include various user preferences such as a maximum size of an attachment, a minimum average data transfer rate, a time of day, a priority level, and the like.

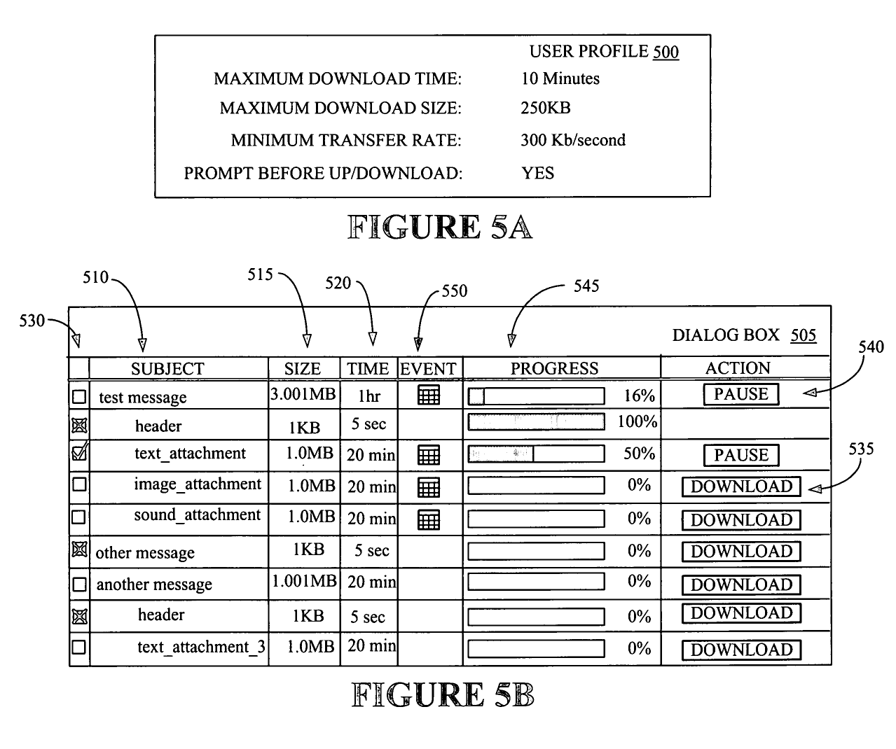

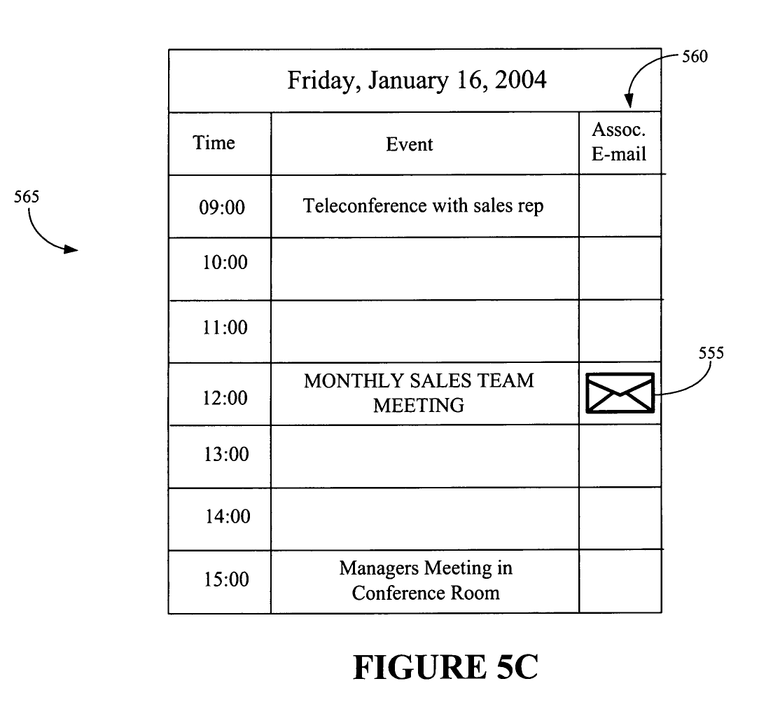

In one embodiment, illustrated in FIG. 5A, a user may provide a user profile 500 indicating the user preferences that may be used to determine (at 430) the mail transfer criteria. For example, the user may indicate, via the user profile 500, that e-mails that can be downloaded within a preselected time (e.g., in 10 minutes or less) should be downloaded. Alternatively, the user profile 500 may indicate that e-mails smaller than a preselected size (e.g., about 250 KB or less) should be downloaded, that e-mails that can be downloaded at an average rate of greater than a preselected threshold (e.g., about 300 Kbps) should be downloaded, and/or that the user should be prompted before the e-mail is uploaded and/or downloaded. In one embodiment, some or all of the information stored in the user profile 500 may be manually provided by the user when the user connects to access the stored e-mails, or, alternatively, the information, if pre-stored, may be made available to a device (e.g., the server 110) desiring access to the stored information. Depending on the implementation, the user profile 500 may be pre-stored at any desirable location, including the processor-based devices 105(1-2), 301, the servers 110, 305, and the like.

For illustrative purposes, it is assumed that the user profile 500 is stored in a convenient location, and, if desired, can be accessed by the appropriate device and/or module, including the e-mail modules 160(1-2), 320, the e-mail management module 125, and the like. In one embodiment, when the user is ready to process one or more of the received e-mails, a message indicative of the information included in the user profile 500 may be sent to a server, such as the servers 110, 305, which may set flags based upon the user preferences. For example, the flags may indicate that the servers 110, 305 should queue and hold e-mails that are to be sent and/or received via a high speed connection, should not download attachments larger that the Maximum Download Size indicated in the user profile 500, should prompt before uploading and/or downloading attachments, and the like.

In some embodiments, flags may also be set on the processor-based-devices 105(1-2), 301 and other devices (not shown) such as third-party proxy servers, e.g. mail servers, and the like. However, persons of ordinary skill in the art should appreciate that the other devices, such as proxy servers, may have additional rules for handling e-mails. For example, a mail server may operate according to a rule that limits the size and/or number of copies of an e-mail that may be sent. The device rules may, in some instances, override the preferences and/or flags that may be determined according to some embodiments of the present invention. For example, the mail server may decline to send copies of a 50 MB e-mail to 100 users, regardless of the preferences that may be indicated by the user profile 500 and/or the flags that may be set on the processor-based-devices 105(1-2), 301 and other devices.

A portion of the electronic mail message is then selected (at 440) based upon the determined data transfer rate, the determined size of the electronic message, and the mail transfer criteria. In one embodiment, the determined data transfer rate and the determined size of the electronic mail message may be used to estimate the total transfer time for the electronic message. The estimated transfer time may then be compared to the threshold time and, if the estimated transfer time does not exceed the threshold time, substantially all of the electronic mail message may be selected (at 440). However, if the estimated transfer time substantially exceeds the threshold time, a portion of the electronic mail message may be selected (at 440). In one embodiment, the e-mail management module may also provide the user with an option to select (at 440) the portion of the electronic mail message.

In one embodiment, illustrated in FIG. 5B, a dialog box 505 may be displayed to the user. However, persons of ordinary skill in the art will appreciate that the present invention is not limited to the dialog box 505. In alternative embodiments, any desirable type of user interface, including a graphical user interface or display, may be displayed to the user in order to provide information to, and/or receive information from, the user. The dialog box 505 may display a list of the e-mails and information associated with the e-mails. For example, as shown in FIG. 5B, one entry (indicated by the phrase “test message” in subject field 510) has a size field 515 that indicates that the size of the e-mail is approximately 3.001 MB and a download time field 520 that indicates that the entire e-mail may take approximately one hour to download at the current connection speed. Various portions and/or attachments may also be displayed in the dialog box 505. For example, the size field 515 indicates that the size of the header is approximately 1 KB and the download time field 520 indicates that the header may take approximately 5 seconds to download at the current connection speed. For another example, the size field 515 indicates that the size of the text_attachment is approximately 1.0 MB and the download time field 520 indicates that the text_attachment may take approximately 20 minutes to download at the current connection speed.

The e-mails, portions thereof, and/or attachments displayed in the dialog box 505 may be determined in a variety of ways. In one embodiment, a user may determine the e-mails, portions, and/or attachments displayed in the dialog box 505. For example, a user may create an e-mail including one or more tags that indicate which e-mail portions and/or attachments should be displayed in the dialog box 505. For another example, a user may highlight a portion of the e-mail by clicking-and-dragging over the desired portion of the e-mail using a controllable pointer element, e.g. a mouse, a joystick, and the like. The user may then indicate that the highlighted portion should be displayed in the dialog box 505 by, for example, selecting an option from a drop-down menu using the controllable pointer element. The e-mail management module may then determine displayable information associated with the e-mails including, but not limited to, the size and estimated download time of the e-mail portions and/or attachments. However, persons of ordinary skill in the art should appreciate that the present invention is not limited to embodiments wherein the user determines the portions and/or attachments displayed in the dialog box 505. In alternative embodiments, the e-mail management module may determine the portions and/or attachments displayed in the dialog box 505. For example, the e-mail management module may determine the portions and/or attachments displayed in the dialog box 505 using information such as the user profile, the device profile, the file size, the connection speed, the estimated download time, and the like.

In one embodiment, the e-mail management module may select (at 440) portions of the e-mails to be downloaded. For example, based upon the user profile 500, the e-mail management module may select (at 440) the “header” of the “test message,” the “other message,” and the “header” of the “another message,” as indicated by the X-marks in selection field 530. Alternatively, the user may select (at 440) portions of the e-mail to be downloaded. For example, the user may control a pointer element on the graphical user display with a pointer controller having position and selection status responsive to operation by the user, such as a mouse, a joystick, and the like, to select (at 440) the text_attachment of the test message. For example, the user may use a mouse to click the box in the selection field, thereby selecting (at 440) the text_attachment, as indicated by the check-mark in the selection field 530.

The selected portion of electronic mail message is then provided (at 450) to, for example, a processor-based device and/or a server, as discussed in detail above. In one embodiment, the e-mail management module may also provide the user with an option to provide (at 450) the selected portion of the electronic mail message. For example, a dialog box may be displayed to the user and the user may opt to provide (at 450) the selected portion or the user may opt not to provide (at 450) the selected portion. In this embodiment, the selected portion of the electronic mail message is provided (450) in response to the user opting to provide (at 450) the selected portion.

In one embodiment, the electronic mail message is queued and/or stored, e.g. on a client or on a server, after the selected portion of the electronic mail message is provided (at 450). The electronic mail message may remain queued until it becomes desirable to provide the complete electronic mail message. In one embodiment, a user may create the electronic mail message on a processor-based device and the selected portion of the electronic mail message may be provided (at 450) to a server and/or another processor-based device. The electronic mail message may remain queued and/or stored on the processor-based device until it becomes desirable to provide the complete electronic mail message to the server and/or other processor-based device. Alternatively, the electronic mail message may remain queued and/or stored on a server until it becomes desirable to provide the complete electronic mail message. As discussed above, one or more notifications may be provided to the user indicating that the electronic mail message is queued and/or stored.

One or more of the electronic mail messages, or portions thereof, may be associated with a time and/or a scheduled event. For example, a user may schedule a meeting and distribute materials to the meeting participants in an electronic mail message, which may include one or more attachments. A meeting notification may also be provided to the users who may participate in the meeting. However, as discussed above, not all of the electronic mail message and/or the attachments may be provided to the users. Thus, a user may want to transfer undelivered portions of the associated electronic mail messages, such as the portions that may be queued and/or stored on a server and/or other processor-based device, prior to the associated time and/or event. In one embodiment, the association of an electronic mail message with the scheduled time and/or event may be indicated by a calendar icon located in the event field 550, shown in FIG. 5B. Alternatively, the association of the electronic mail message with the scheduled time and/or event may be indicated by an envelope icon 555 located in an associated e-mail field 560 of a calendar entry 565, as shown in FIG. 5C.

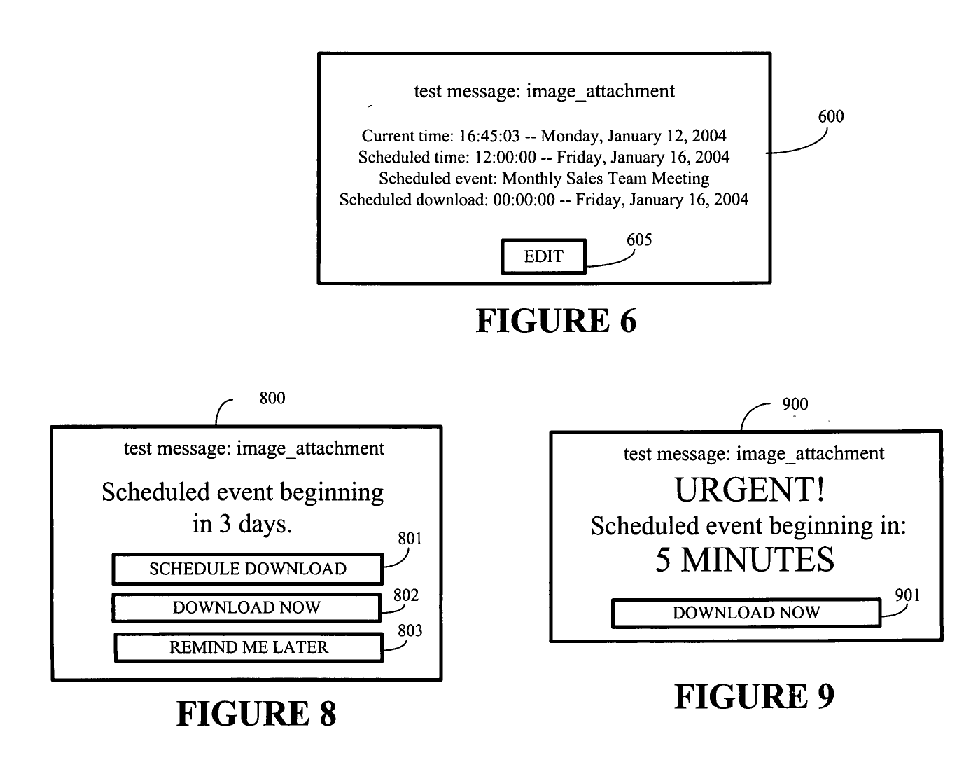

In one embodiment, the user may view the current status of portions of the electronic mail message. For example the user may select (e.g. with a mouse, a joystick, and the like) the calendar icon in the event field 550 associated with one or more portions of the electronic mail message or the envelope icon 555. In response to the user selection, a dialog box 600 may be displayed, as shown in FIG. 6. In one embodiment, the dialog box 600 may display information including the file name, the title of the attachment, a current time, a scheduled time and/or event, a scheduled download time, and the like. However, persons of ordinary skill in the art should appreciate that any desirable information may be displayed in the dialog box 600. An edit button 605 may also be provided in the dialog box 600. In one embodiment, the user may select the edit button 605 to be provided with an option to edit one or more of the entries in the dialog box 600. For example, the user may choose to change the scheduled download time to a more desirable time. Persons of ordinary skill in the art should also appreciate that, in alternative embodiments, an e-mail management module, a server, and the like may schedule the download time. For example, the e-mail management module may automatically schedule a transfer time based upon such factors as default times, historical usage patterns, connection speeds, and the like. The e-mail management module may also prompt the user to connect on-demand.

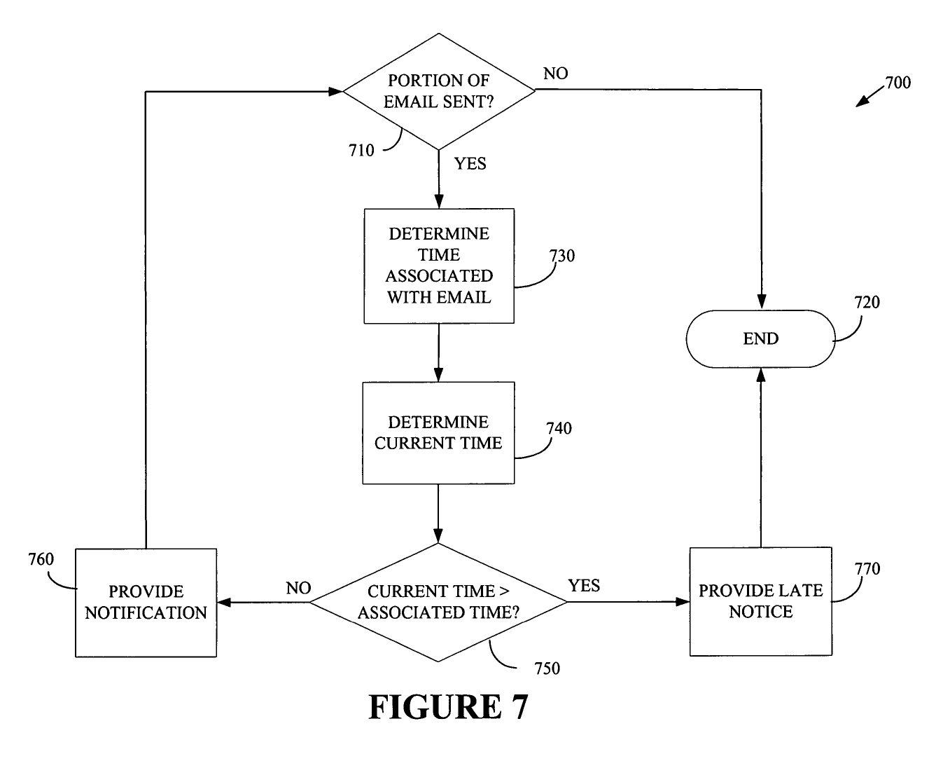

Although the user may be provided with the aforementioned tools to download portions of an electronic mail message prior to the time and/or event associated with the electronic mail message, the user may not always utilize these tools. Thus, a method 700 for providing a notification of an undelivered portion of an electronic mail message based on a calendar entry may also be provided. One embodiment of the method 700 is shown in FIG. 7. In the illustrated embodiment, an e-mail management module, such as the e-mail management modules 125, 310 shown in FIGS. 1 and 3, determines (at 710) whether or not a portion of an e-mail has been delivered to an intended recipient. For example, the e-mail management module may determine (at 710) that less than all of an electronic mail message has been delivered to one or more users associated with one or more processor-based devices, one or more servers, and the like. In various alternative embodiments, the e-mail management module may determine (at 710) that a portion of the electronic mail message has been delivered to the intended recipient by accessing a queue, a storage medium, a register, a flag associated with the electronic mail message, a marker associated with the electronic mail message, and the like. If the e-mail management module determines (at 710) that all desirable portions of the electronic mail message have been delivered to the intended recipient, the method 700 may end (at 720).

If the e-mail management module determines (at 710) that at least one portion of the electronic mail message has not been delivered to the intended recipient, the e-mail management module determines (at 730) a time and/or event associated with the electronic mail message. In one embodiment, the associated time and/or event may include a date and a time of day, a meeting, a telephone call, and the like, which may be determined (at 730) by accessing a calendar or by accessing a portion of the electronic mail message. For example, the time field 245 may be used to associate the electronic mail message with an entry in a calendar or schedule. The e-mail management module may then access the calendar or schedule entry associated with the electronic mail message to determine (at 730) the associated time. For example, the associated time may be a date and a time of day of a scheduled meeting, appointment, and the like. A current time may also be determined (at 740) by, for example, accessing a clock.

The e-mail management module may then compare (at 750) the associated time and the current time and provide (at 760) one or more notifications if it is determined (at 750) that the current time is earlier than the associated time. For example, as shown in FIG. 8, the e-mail management module may provide a notification 800, which may include information such as the file name, the attachment, how long until the scheduled time and/or event, and the like. In one embodiment, the notification 800 may include one or more buttons 801, 802, 803 that allow the user to initiate one or more actions. For example, the notification 800 may include a schedule download button 801 that allows the user to schedule the download for a later time, a download now button 802 that allows the user to initiate the download substantially immediately, a remind me button 803 that requests another notification at a later time, and the like.

In various alternative embodiments, as described above, the notification may be provided (at 760) to the intended recipient, such as a user associated with a processor-based device or a server, or to a distributor of the electronic mail message, which may be a user associated with the processor-based device, an automated mail server, and the like. In one embodiment, along with the notification, the user may be provided with an option to receive and/or send electronic mail message immediately or at a scheduled time. If the e-mail management module determines (at 750) that the current time is later than the associated time, a late notice may be provided (at 770) and the method 700 may end (at 720).

Once the notification has been provided (at 760), the e-mail management module may determine (at 710) whether or not the e-mail has been provided to the intended recipient. For example, the e-mail management module may wait a predetermined time after the notification has been provided (at 760) before determining (at 710) whether or not the electronic mail message has been delivered to the intended recipient. In one embodiment, the frequency at which the associated time and the current time are compared (at 750), as well as the urgency of the notifications, may increase as the difference between the associated time and the current time decreases. For example, the e-mail management module may provide an urgent notification 900, as shown in FIG. 9. In one embodiment, the urgent notification 900 may include one or more buttons 901 such as a download now button 901 that allows the user to initiate the download substantially immediately. In one embodiment, the notifications 800, 900 may only be provided when the difference between the associated time and the current time is less than a preselected value. The preselected value, as well as the frequency and/or urgency of the notifications, may be specified by a user and/or a user profile.

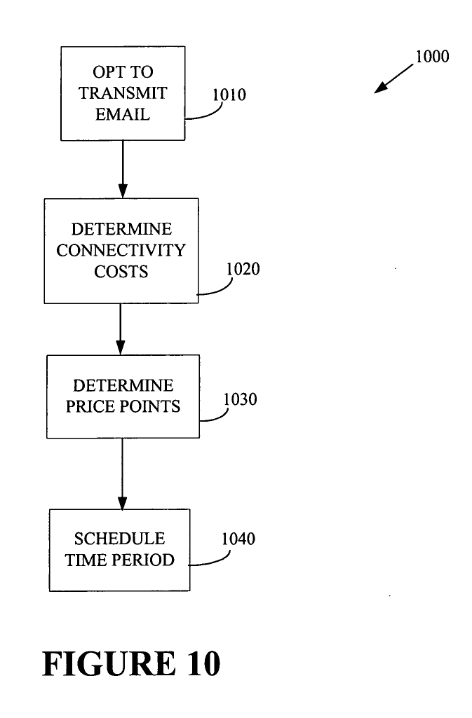

As mentioned above, in some alternative embodiments, the user may be provided with an option to receive and/or send electronic mail message at a scheduled time. FIG. 10 illustrates one embodiment of a method 1000 of scheduling a time period for providing the electronic mail message to the intended recipient. In the illustrated embodiment, the user opts (at 1010) to receive and/or send the electronic mail message. An e-mail management module may determine (at 1020) the connectivity costs, such as the subscription cost of an Internet connection provided by an Internet Service Provider, the cost of a telephone call used for a dial-up connection, and the like, associated with transmitting the electronic mail message via one or more communication paths (e.g. the communication paths 130(1-2), 340) and during one or more time periods.

The e-mail management module may also determine (at 1030) one or more price points based on the determined connectivity costs. For example, the e-mail management module may determine (at 1030) that it will cost $25.00 in connectivity costs to transmit the electronic mail message via a dial-up connection requiring a long-distance telephone call from a gas station on Monday afternoon, but be substantially free if the electronic mail message is transmitted from home later that evening via a cable modem. A time period for providing the electronic mail message may then be scheduled (at 1040) based upon the one or more price points, as well as any other desirable criteria, such as bandwidth availability, user availability, historical access information, and the like. In alternative embodiments, the transfer time may be scheduled (at 1040) based upon based upon an estimated transfer time and a difference between the time associated with the electronic mail message and the current time. For example, if only 10 minutes remain between the current time and the time of a scheduled event associated with the electronic mail message, and the estimated transfer time is about 10 minutes, the time period for providing the electronic mail message may then be scheduled (at 1040) substantially immediately.

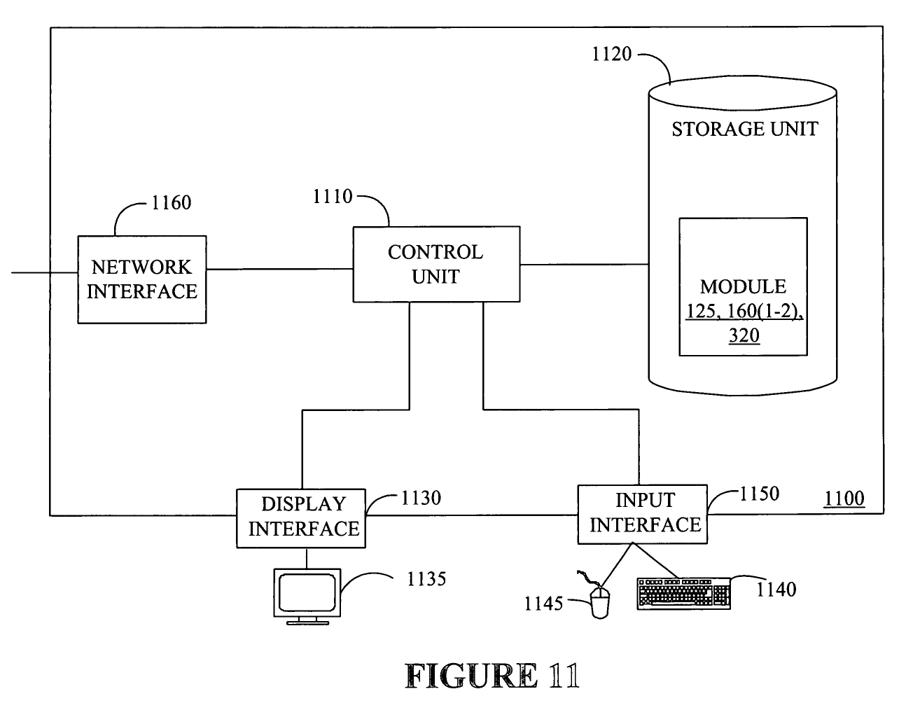

FIG. 11 shows a stylized block diagram of a processor-based device 1100, in accordance with one embodiment of the present invention. In one embodiment, the processor-based device 1100 may represent portions of the processor-based devices 105(1-2), 301 and/or the servers 110, 305. The device 1100, depending on the particular implementation, is configured with the appropriate software configuration, including the e-mail management module 125 or the e-mail modules 160(1-2) of FIG. 1, or with the e-mail management module 320 in the system 300 of FIG. 3.

The device 1100 comprises a control unit 1110, which in one embodiment may be a processor that is communicatively coupled to a storage unit 1120. The software installed in the storage unit 1120 may depend on the features to be performed by the device 1100. For example, if the device 1100 represents one of the processor-based devices 105(1-2), 110, 301, 305 then the storage unit 1120 may include the e-mail management modules 125, 320, as well as the e-mail modules 160(1-2). The e-mail management modules 125, 320 and the e-mail modules 160(1-2) may be executable by the control unit 1110. Although not shown, it should be appreciated that in one embodiment an operating system, such as Windows®, Disk Operating System®, Unix®, OS/2®, Linux®, MAC OS®, or the like, may be stored on the storage unit 1120 and be executable by the control unit 1110. The storage unit 1120 may also include device drivers for the various hardware components of the device 1100.

In the illustrated embodiment, the device 1100 includes a display interface 1130. The device 1100 may display information on a display device 1135 via the display interface 1130. In the illustrated embodiment, a user may input information using an input device, such as a keyboard 1140 and/or a mouse 1145, through an input interface 1150. The control unit 1110 is coupled to a network interface 1160, which may be adapted to receive, for example, a local area network card. In an alternative embodiment, the network interface 1160 may be a Universal Serial Bus interface or an interface for wireless communications. The device 1100 communicates with other devices through the network interface 1160. Although not shown, associated with the network interface 1160 may be a network protocol stack, with one example being a UDP/IP or a TCP/IP stack. In one embodiment, both inbound and outbound packets may be passed through the network interface 1160 and the network protocol stack.

It should be appreciated that the block diagram of the device 1100 of FIG. 11 is exemplary in nature and that in alternative embodiments, additional, fewer, or different components may be employed without deviating from the spirit and scope of the instant invention. For example, if the device 1100 is a computer, it may include additional components such as a system bus or an I/O bus. In other embodiments, the various elements of the device 1100 may be interconnected using various buses and controllers. Similarly, depending on the implementation, the device 1100 may be constructed with other desirable variations without deviating from the spirit and scope of the present invention.

The various system layers, routines, or modules may be executable on control units, such as the control unit 1110. The control unit 1110 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed or removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 1110 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
determining that less than all of an electronic mail message has been transmitted, the electronic mail message including scheduling information indicative of a calendar event;
associating the electronic mail message with the calendar event based upon the scheduling information; and
providing a notification that less than all of the electronic mail message has been transmitted based on the calendar event.

2. The method of claim 1, wherein providing the notification comprises:
determining a time associated with the calendar event;
determining a current time; and
determining a difference between the time associated with the electronic mail message and the current time.

3. The method of claim 2, wherein providing the notification comprises providing a plurality of notifications having at least one of a provision frequency and an urgency that increases as the difference between the time associated with the electronic mail message and the current time decreases.

4. The method of claim 3, wherein providing the plurality of notifications having at least one of the provision frequency and the urgency comprises providing the plurality of notifications having a provision frequency determined by a user profile.

5. The method of claim 2, wherein providing the notification comprises providing a late notice if the current time exceeds the time associated with the electronic mail message.

6. The method of claim 1, further comprising providing the electronic mail message.

7. The method of claim 6, wherein providing the electronic mail message comprises scheduling a time period for providing the electronic mail message.

8. The method of claim 7, wherein scheduling the time period for providing the electronic mail message comprises scheduling the time period for providing the electronic mail message based upon at least one of a default time, a historical usage pattern, and a connection speed.

9. The method of claim 6, wherein providing the electronic mail message comprises prompting a user to connect on-demand.

10. The method of claim 6, wherein providing the electronic mail message comprises determining whether a user has received substantially all of the electronic mail message.

11. The method of claim 6, wherein providing the electronic mail message comprises determining a cost of connectivity.

12. The method of claim 11, wherein providing the electronic mail message comprises determining a price point based upon the determined cost of connectivity.

13. The method of claim 1, wherein determining that determining that less than all of the electronic mail message has been transmitted comprises:
accessing at least one of a queue, a storage medium, a register, and a flag; and
determining that less than all of the electronic mail message has been transmitted to the intended recipient using the accessed queue, storage medium, register, or flag.

14. A method, comprising:
determining that less than all of an electronic mail message has been transmitted, the electronic mail message including scheduling information indicative of a calendar event;
associating the electronic mail message with the calendar event based upon the scheduling information;
providing a notification that less than all of the electronic mail message has been transmitted based on the calendar event;
determining a value associated with a data transfer rate;
determining a value associated with a size of an undelivered portion of the electronic mail message; and
scheduling a transfer time for the undelivered portion of the electronic mail message based upon the determined transfer rate value, the determined value associated with the size of the electronic mail message, and the calendar event.

15. The method of claim 14, wherein scheduling the transfer time comprises estimating a transfer time based upon at least one of the determined transfer rate value and the determined value associated with the size of the electronic mail message.

16. The method of claim 15, wherein scheduling the transfer time comprises:
determining a time associated with the calendar event;
determining a current time; and
determining a difference between the time associated with the electronic mail message and the current time.

17. The method of claim 16, wherein scheduling the transfer time comprises scheduling the transfer time based upon the estimated transfer time and the difference between the time associated with the electronic mail message and the current time.

18. The method of claim 14, wherein determining the value associated with the data transfer rate comprises determining an average data transfer rate using data in a received data packet and a time period associated with the received data packet.

19. The method of claim 14, wherein determining the value associated with the data transfer rate comprises determining the value associated with the transfer rate based upon a device profile.

20. The method of claim 14, wherein providing the notification comprises providing at least one of an option to schedule a transfer of the undelivered portion of the electronic mail message, initiate a transfer of the undelivered portion of the electronic mail message, and provide an additional notification at a later time.

21. The method of claim 14, further comprising providing the electronic mail message.

22. The method of claim 21, wherein providing the electronic mail message comprises providing the electronic mail message at the scheduled transfer time.

23. The method of claim 21, wherein providing the electronic mail message comprises providing a user an option to initiate the transfer.

24. A method for interfacing with a user of a computer system having a graphical user display, comprising:
displaying at least one indicator of an event associated with at least one undelivered portion of at least one electronic mail message;
monitoring the position and selection status of a pointer controller to detect that one of the at least one indicator has been selected by the user; and
providing scheduling information associated with the at least one undelivered portion of the at least one electronic mail message and the event in response to detecting that one of the at least one indicators has been selected by the user.

25. The method of claim 24, wherein providing the scheduling information comprises providing at least one of a current time, a scheduled time, a scheduled event, and a scheduled download time.

26. The method of claim 24, further comprising providing an option to modify the scheduling information associated with the at least one undelivered portion of the at least one electronic mail message and the event in response to detecting that one of the at least one indicators has been selected by the user.

27. The method of claim 24, further comprising displaying a notification associated with the at least one undelivered portion of the at least one electronic mail message based upon the scheduling information.

28. The method of claim 24, wherein displaying the notification comprises providing at least one of an option to schedule a transfer of the at least one undelivered portion of the at least one electronic mail message, initiate a transfer of the at least one undelivered portion of the at least one electronic mail message, and provide an additional notification at a later time.

29. The method of claim 24, further comprising controlling a pointer element on the graphical user display with a user pointer controller, the pointer controller having position and selection status responsive to operation by the user.

30. The method of claim 24, wherein displaying the at least one indicator of the event comprises displaying at least one of an envelope icon and a calendar icon.
